(19) United States
(12) Patent Application Publication
(10) Pub. No.: US 2017/0228381 A1
(43) Pub. Date: Aug. 10, 2017

(54) METHOD AND SYSTEM FOR TRACKING AN OBJECT AND USER ACTIONS ASSOCIATED THEREOF

(71) Applicant: Pawel Nazaruk, Biala Podlaska (PL)

(72) Inventor: Pawel Nazaruk, Biala Podlaska (PL)

(21) Appl. No.: 15/422,459

(22) Filed: Feb. 1, 2017

Related U.S. Application Data
(60) Provisional application No. 62/292,246, filed on Feb. 6, 2016.

(51) Int. Cl. G06F 17/30; G06F 21/62; G06K 19/10; H04L 29/06

(52) U.S. Cl. CPC G06F 17/30061; H04L 63/083; H04L 63/102; G06F 21/6227; G06K 19/10; G06F 17/30241

(57) ABSTRACT

Disclosed is a system and method for tracking an object and user actions associated with the object using an action tracking platform. The system includes a data acquisition module configured to acquire a first set of data associated with the object from a first user holding the object, and a second set of data related to the first user, an analytics module configured to receive the first set of data and associate the same with the second set of data to determine a third set of data associated with the first set of data, a storage module configured to store the first set of data, and the second set of data, and a processing module configured to process the first set of data, the second set of data, and the third set of data to enable users with tracking location information of the object and corresponding user actions.

### CROSS-REFERENCE TO RELATED APPLICATIONS

This patent application claims priority to U.S. Provisional Patent Application No. 62/292,246, filed Feb. 6, 2016, entitled “METHOD AND SYSTEM FOR ACTION TRACKING” to Pawel Nazaruk, the contents of which are incorporated herein in its entirety.

### FIELD OF THE INVENTION

The present application generally relates to a tracking mechanism and in particular, it relates to tracking actions performed by users. More particularly, embodiments of the present invention are directed towards recommending one or more user actions to users, and tracking of an object and associated user actions.

### BACKGROUND

In recent years, due to increased competition among users, the users are mainly found focused on caring about themselves and their loved ones. The users are slowly getting isolated from society. The users are less motivated towards understanding essential parts of life, such as importance of being socially acceptable and importance of act of kindness that can make earth a better place to live in for everyone. Essential part of the social dos or the act of kindness is that it inspires numerous other users to perform different social actions.

Further, it is known fact that inspiration is needed for people to perform social actions or the acts of kindness. Normally, users get inspired when they get to know about someone's actions and outcomes about those actions. Now a days, it is observed that amount of information that users share online has increased dramatically. Many web platforms provide an online community with content focused on a common interest or theme, and such platforms allow lots of users to join and share personal information, and information on various social actions or the act of kindness that they perform with other users of the community. Similarly, use of online social networking sites has also been rapidly gaining popularity for sharing information on various topics. Information has always remained in demand. However, access to accurate information that may inspire numerous users to perform social actions or the act of kindness is challenging. Similarly, tracking social actions performed by the users that might be inspiring to other users has remained unaddressed in the past.

U.S. Pat. No. 8,700,636B2 assigned to Facebook® Inc discloses about clustering related actions received from users of a social-networking system for news feeds. According to the application, actions that are related to each other may be grouped together into action groups. For example, if there is an event organized through the social networking system and there are photos taken at the event and uploaded to the social networking system by multiple users attending the event, the photos and the event may be grouped into the same action group because they are related.

Thus, in the light of the above mentioned background art, it is evident that, in conventional systems and methods, tracking social actions or acts of kindness of users and providing accurate information on social actions performed by the users that may inspire numerous other users to perform social actions has remained unaddressed. Thus, there is a need for a method and system that would overcome above stated problem.

### BRIEF SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

It is an objective of the present invention to provide a method and system for tracking an object, and user actions associated with the object.

Another objective of the present invention is to provide a method and system that would enable tracking a chain of user actions or reactions by multiple users associated with the object.

Another objective of the present invention is to provide a method and system that would inspire and motivate users for doing social service actions or various acts of kindness and would be interesting for the users.

According to an embodiment of the invention, there is provided a system for tracking an object, and one or more user actions associated with the object using an action tracking platform communicatively coupled with one or more communication devices. The system including a data acquisition module, configured to acquire a first set of data associated with the object from a first user in possession of the object, and a second set of data provided by and related to the first user, an analytics module, configured to receive the first set of data associated with the object acquired by the data acquisition module, associate the first set of data associated with the object to the second set of data related to the first user, and determine a third set of data associated with the first set of data.

According to the embodiment, the system further includes a storage module, configured to store the first set of data associated with the object, the second set of data associated with the user, and one or more processing module, configured to process the first set of data associated with the object, the second set of data associated with the user, and the third set of data determined by the analytics module, wherein the processing of the first set of data, the second set of data, and the third set of data by the one or more processing module resulting in tracking of one or more locations of the object, and the user actions associated with the object.

According to another embodiment, there is provided a method for tracking an object, and one or more user actions associated with the object, the method being performed by an action tracking platform communicatively coupled with one or more communication devices, the method comprising the steps of: acquiring, by a data acquisition module, a first set of data associated with the object from a first user in possession of the object, and a second set of data provided by and related to the first user.

According to the embodiment, the method further including the steps of receiving, by an analytics module, the first set of data associated with the object acquired by the data acquisition module, associating, by the analytics module the first set of data associated with the object to the second set of data related to the first user, determining, by the analytics module a third set of data associated with the first set of data, storing, by a storage module, the first set of data associated with the object, the second set of data associated with the user, and processing, by one or more processing module, the first set of data associated with the object, the second set of data associated with the user, and the third set of data determined by the analytics module, wherein the processing of the first set of data, the second set of data, and the third set of data by the one or more processing module resulting in tracking of one or more locations of the object, and the user actions associated with the object.

Systems and methods of varying scope are described herein. In addition to the aspects and advantages described in this summary, further aspects and advantages will become apparent with reference to the drawings and the detailed description that follows.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 is a schematic diagram representing a system for tracking an object and user actions associated with the object using an action tracking platform presented as an application over communication devices held by the users, in accordance with an embodiments of the present invention.

FIG. 2 is a simplified diagram showing chain formation between multiple users when one user in possession of the object pass on the object to the subsequent users that in turn give rise to chain of user actions associated with the object, according to the embodiment of the present invention.

FIG. 3 illustrates a representative block diagram of the action tracking platform, in accordance with an embodiments of the present invention.

FIG. 4A-4B are diagrams illustrating front view, and back view of an exemplary object, in accordance with an embodiment of the present invention.

FIG. 5A-5F are representative screenshots showing various functionalities of the action tracking platform, in accordance with embodiments of the present invention.

FIG. 6 illustrates a method for tracking an object and user actions associated with the object, in accordance with an embodiment of the present invention.

### DETAILED DESCRIPTION

Some embodiments, illustrating its features, will now be discussed in detail. The words “comprising”, “having”, “containing” and “including”, “comprises of” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Further, in the context of the present invention the terms ‘mission’, ‘actions’, ‘user actions’, ‘recommended user actions’, ‘act of kindness’, ‘good deed’ and other forms thereof are synonymously used throughout the description.

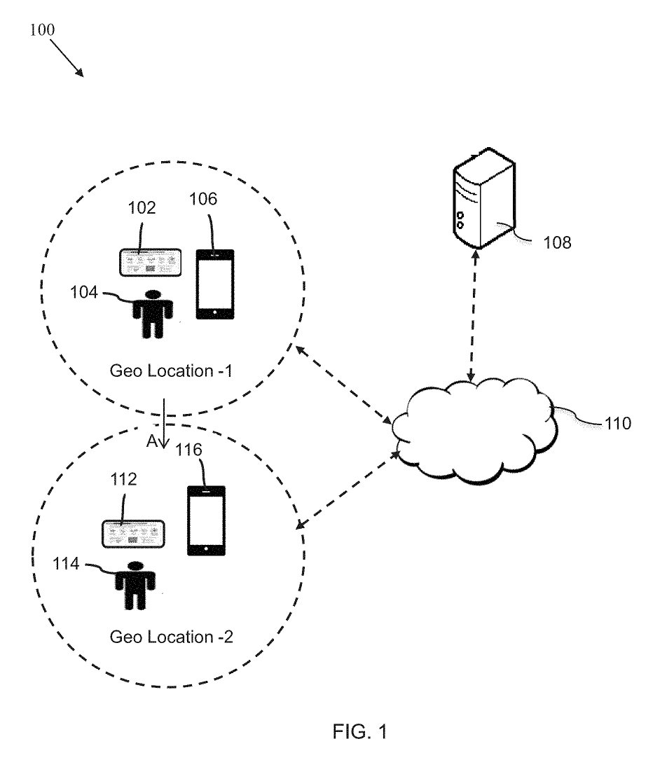

Further, the following detailed description is intended to provide example implementations to one of ordinary skill in the art, and is not intended to limit the invention, as one of ordinary skill in the art will understand that variations can be substituted that are within the scope of the invention as described. Further, relational terms such as first and second, and the like, may be used to distinguish one entity from the other, without necessarily implying any actual relationship or order between such entities. Reference will now be made to the accompanying drawings: FIGS. 1-6.

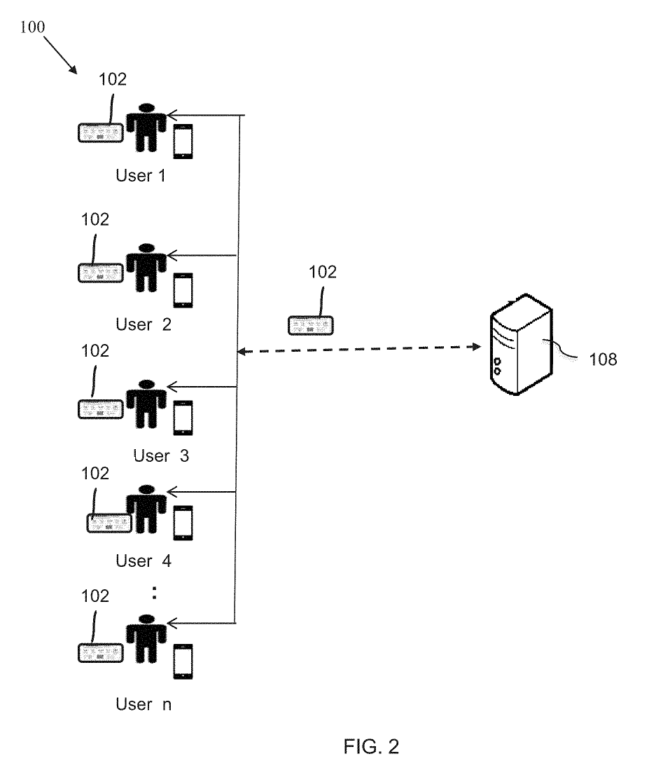

Referring to FIG. 1 is a schematic diagram representing a system for tracking an object and user actions associated with the object using an action tracking platform presented as an application over a communication devices held by the users. The system 100 shows a geo location-1 with an object 102, a first user 104, a communication device 106 associated with the user 104, a geo location-2 with an object 112, a second user 114, a communication device 116 associated with the user 114. For the purpose of understanding, it should be understood that the object 102, 112 are essentially the same object 102 held by the user 102 who may later pass on the object 102 to the user 114, or subsequent users as more clearly shown in FIG. 2, which will be explained in detail later on. Although for the purpose of illustration and understanding only two users 104,114 are shown in the FIG. 1, it should be understood that the invention can be practiced by several users connected together by the object 102 in the form of a chain, as shown in FIG. 2.

Further, for the purpose of understanding the invention, the users 104, 114 may preferably be considered as an individual, an admin, a social worker, a caretaker, an assistant, a celebrity, and any authority. Similarly, the object 102 may preferably include but is not limited to a card (Eg. smart card, visiting card), a coin, a badge, a user wearable device (Eg. a necklace, a bracelet, a wristband), a keychain, or other physical block of suitable material. The scope of the invention is not limited to the type of material used for manufacturing the object 102, shape and dimension of the object 102. Also, although only one type of communication device 106,116, namely a smart phone is shown associated with the users 104,114. It should be understood that the users 104,114 may possess one or more communication devices 106, 116 from the group of, but not limited to a cell phone, a smart phone, a cellular phone, a cellular mobile phone, a personal digital assistant (PDA), a navigation terminal, a personal computer, a laptop, and a tablet computer.

Further, the system 100 includes an action tracking platform 108 configured as an application on the communication devices 106,116 held by the users 104,114, or any previous or subsequent users as illustrated in FIG. 2. The action tracking platform 108 once configured and is accessible by the users 104, 114 using their communication devices 106,116 over a communication network 110 will effectively enable the users 104, 114 to track the object 102, 112, and the user actions associated with the object 102,112.

In the context of present invention, the communication network 110 may include, but are not limited to a local area network, a wide area network, a radio network, a virtual private network, an internet, a metropolitan area network, a satellite network, Wi-Fi, Bluetooth Low energy, a beacon, a wireless network, and a telecommunication network. Examples of the telecommunication network include, but are not be limited to a global system for mobile communication (GSM) network, a general packet radio service (GPRS) network, third Generation Partnership Project (3GPP), 4G, Long-Term Evolution (LTE), an enhanced data GSM environment (EDGE) and a Universal Mobile Telecommunications System (UMTS).

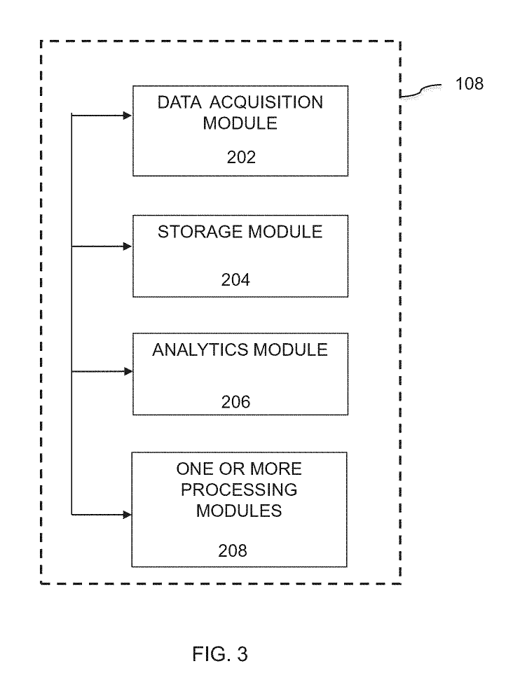

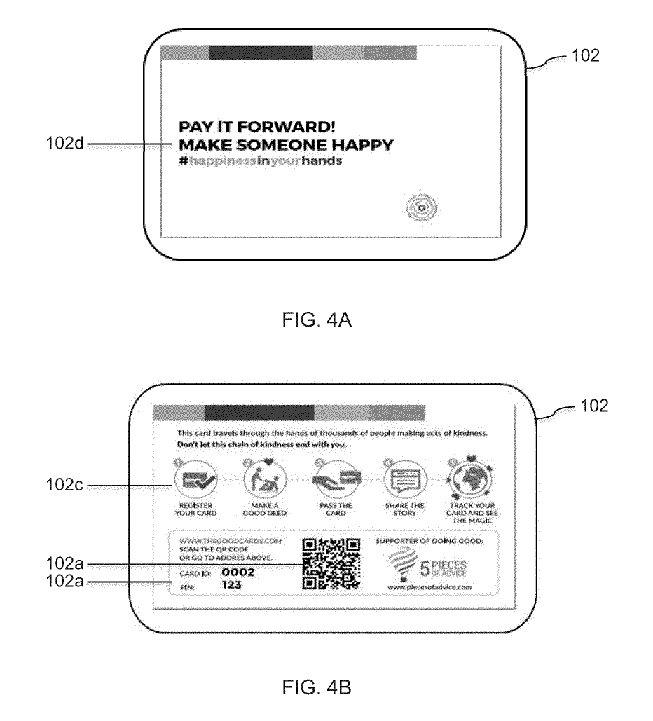

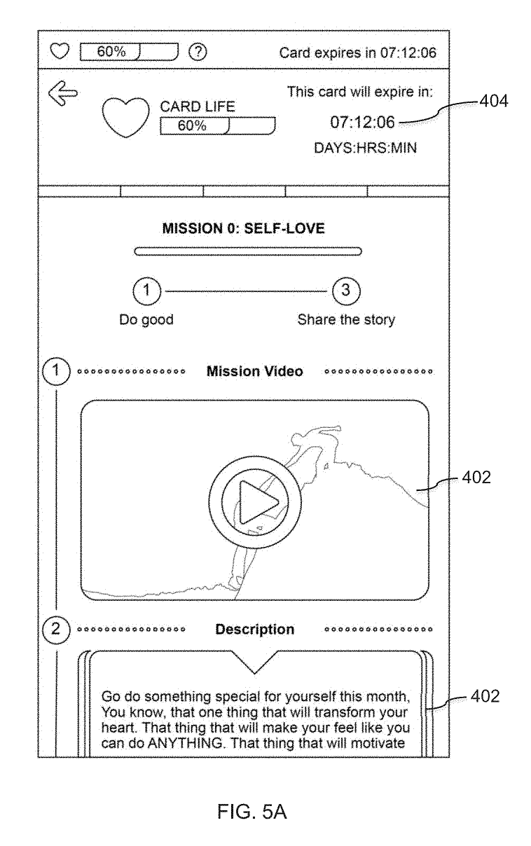

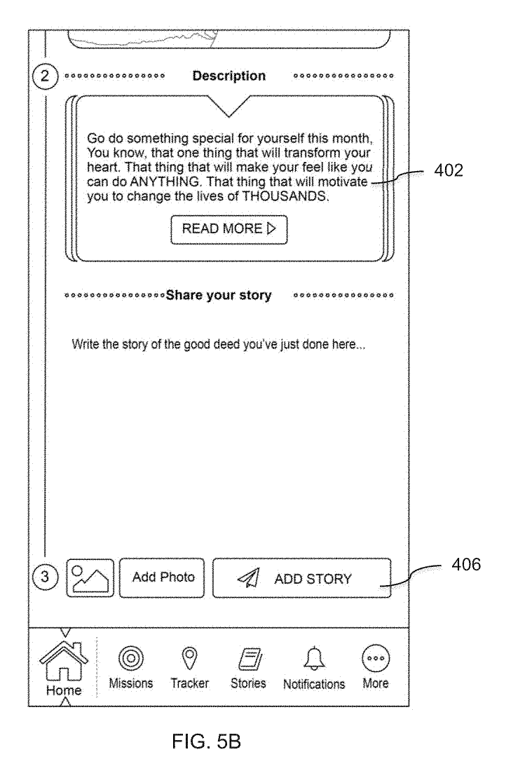

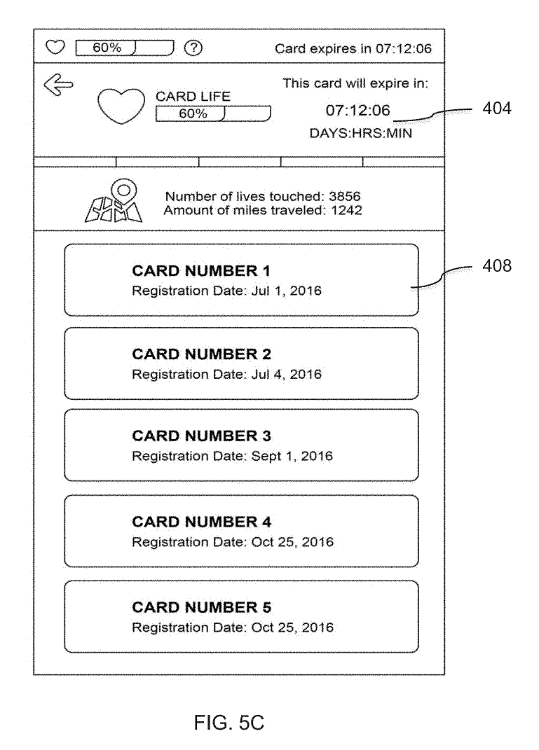

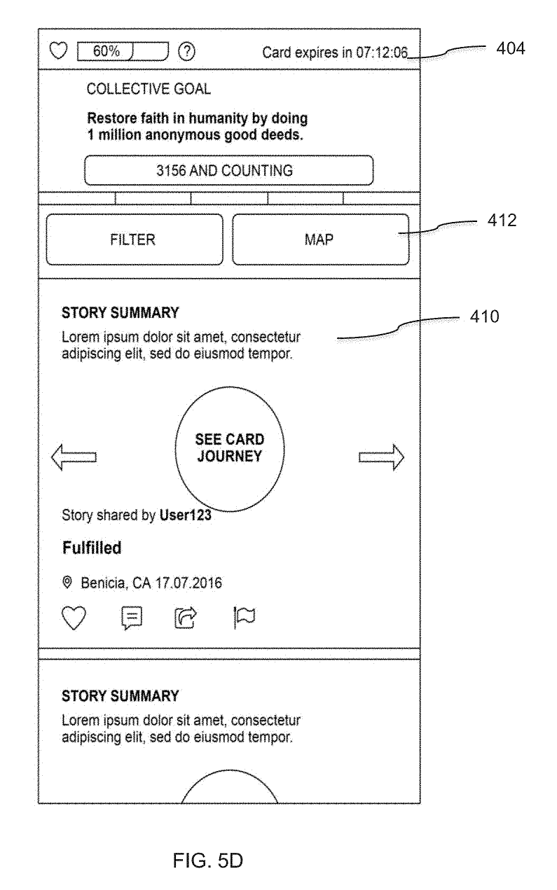

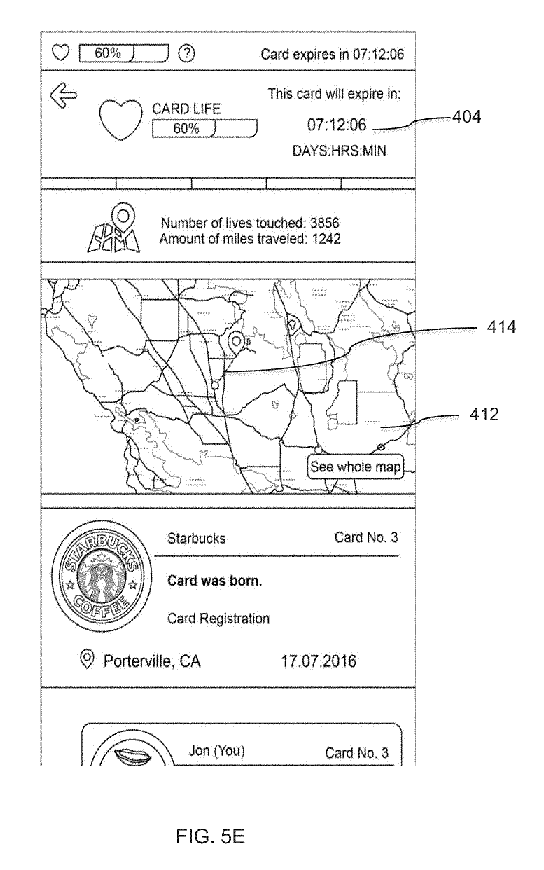

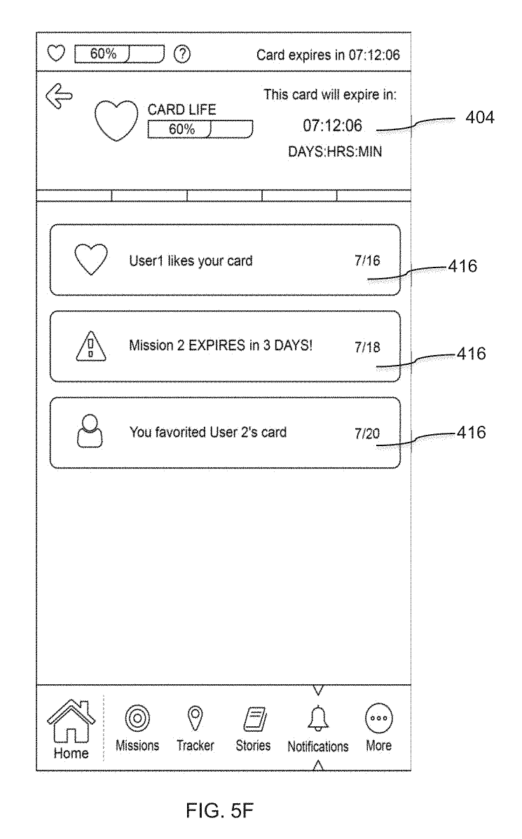

The methodology for tracking the object 102,112 and user actions associated with the object 102, 112, will now be described in detail with reference to FIG. 1, FIG. 3, FIGS. 4A-4B and FIGS. 5A-5F.

According to an embodiment of the invention, the user 104 at geo location-1 may have access to the object 102 (Eg. a card). The user 104 may receive the object 102 from a third party for free or for a prescribed fee, the third party may include be but not limited to a company, an institution, an individual, a social activity group, associated partners, such as coffee shops, and a social organization. According to an embodiment, the user 104 may receive the object 102 once the user 102 successfully registers with the action tracking platform 108. The action tracking platform 108 embodies various modules and submodules as shown in FIG. 3, that helps track the object 102 and user actions associated with the object 102.

According to the embodiment, the object 102 includes a first set of data as shown in FIGS. 4A-4B. The first set of data preferably includes at least one an authorization code, a brief guide and one or more recommended user actions. In the context of present invention terms like user actions, acts of kindness, good deeds, mission, social service actions, social actions and the recommended user actions are synonymously used.

As shown in FIG. 4A, the recommended user actions may comprise of a social service action 102d (For Eg. “Make Someone Happy”) that may need to be performed by the user 104 holding the object 102. For an example, the recommended user action 102d may be a request to register with a website and E-purchase of an article. The article may be a handicraft made by a set of physically challenged people. Other examples for user actions may preferably be but not limited to buying a coffee or food for needy people or for people who didn't had the best day, helping someone with complex project to overcome difficulties.

As shown in FIG. 4B, the authorization code may include, but is not limited to an identity number and a Personal Identification Number (PIN) 102a, object identification numbers 102a, a QR code 102a, an NFC(Near Field communication) code in the form of a tag, or a bar code associated with the object 102. According to the embodiment, length of the Personal Identification Number (PIN) may vary from 4 digits to 10 digits. According to another embodiment, the length of the personal identification number may be more than one digit. Further, the PIN number may be at least one of an alphanumeric code, a Captcha, a barcode, a QR code, an NFC code in the form of tag, and the like. The scope of the invention is not limited to the type of object Identity or the type of PIN used. The authorization code facilitates an authorized access to the action tracking platform 108 by the users.

Further, as shown in FIG. 4B, the object 102 may include a brief guide 102c for the user 104 that may act as user guide for the user 104 directing about the possible actions that the user 104 holding the object 102 is required to perform, For example, the user 104 once have the object 102, may register the object 102 with the action tracking platform 108, perform social action either recommended by the object 102 in association with the platform 108 or any user chosen social actions that may motivate or inspire other users (say user 114). Once the user 104 performs the action or mission, the user 104 is guided to pass on the object 102 to the second user 114 located in other geo location-2 as directed by the arrow ‘A’ in FIG. 1, however it should not be considered as limitation and the object 102 may be passed to the user 114 by the user 104 within same geo location-1. For example, the user 104 living in one specific social neighborhood community can pass on the object 102 to his neighbor or the user 114 residing next to him within same geo location-1, or the user 104 may pass the object 102 to a friend (the user 114) residing far away in next city, country or a region i.e. geo location-2.

Further, once the user 104 has passed on his card to the user 114 after the completion of his mission or user action, the user 104 is enabled to add or post his story or write up 406 about the action or mission performed using the action tracking platform 108 as shown in FIG. 5B that may inspire other users of the platform 108. The story or write up may be in the form of texts, photos, multimedia or any combination thereof.

According to another embodiment, the user 104 may be provided with an online multimedia guide 402 along with texts accessible once the user successfully logs onto the action tracking platform 108, as shown in FIG. 5A instead of a user guide 102c on the object 102. Also, according to the embodiments of the invention, the user actions recommended by the platform 108 or the object 102 may have predefined time limit set 404 for the user 104 performing the action so as to motivate the user 104 to perform the action on time and move onto performing next action or mission as shown in FIGS. 5A-5F.

As described above, once the user 104 has passed on the object to the user 114, the user 114 in possession of the object 112 (object 112 being the same object 102) can then act according to the provided guide 102c or the online multimedia guide and perform his actions or mission that may inspire other users and then pass on the object 112 in his possession to the other users subsequent users located in same or different geographical locations (as shown in FIG. 2) such as to maintain the continuity of passing of the object 112 and form a chain between the users, and keep the acts of kindness or good deed or social actions related to the object 112 ongoing forming chain of user actions or reactions associated with the same object. The user 114 when he passes the object 112 to the next subsequent user as shown in FIG. 2, he may then chose to post his own story related to the action performed by him as described above.

The user 114 in possession of the object 112 may be a registered or unregistered user of the action tracking platform 108. In context of the present invention, the registered user may be the user who has a valid login credentials. The login credentials include, but are not limited to user name, password, an email, and a Captcha. In an embodiment, the password may include at least one of alphabet, number, and special characters. In an embodiment, Captcha is a type of challenge-response test used in computing to determine whether or not the user is human.

Registered user can logon to the action tracking platform 108 either using his login credentials or just use the object 112 associated credentials like authorization code described above to logon to the platform 108. If the user 114 chose to logon to the action tracking platform 108 using the object's 112 associated credentials then the object 112 is automatically registered with the platform 108. If the user 114 elects to logon to the platform 108 using his login credentials, than the user 114 can add the object 112 by entering the object 112 related credentials i.e. the first set of data. Once the object 112 is successfully added, the added object 112 can be viewed 408 by the user 114 as shown in FIG. 5C and any other subsequent users to whom the user 114 may pass on the object 112. The users 104,114 or any subsequent user can select the object 112 (which is actually object 102) whenever the users' desire to track the location of the object i.e. the card.

Although for simplicity of description, we have considered the user 114 to posses' one object 112 passed on by the user 104. It should be understood that that the users 104,114 may be in possession of one or more objects 102,112 at some instant of time which the user 104,114 may be able to view, as actually seen in FIG. 5C. Just by selecting the desired object 112, the user 114 is able to navigate through the stories or the write ups 410 associated with the particular object 112 and is able to track the objects journey over a map 412 specifically a geographical map, as shown in FIG. 5D.

The user 114 upon login is enabled to navigate through the notifications 416 as shown in FIG. 5F generated by the platform 108 using a notification module (not shown). The notifications 416 may preferably include but not limited to likes that the user 114 might have received on the story posted by the user 114 for his previous object, intimation on the time left for the user 114 to complete the mission or action he is involved in, notification on user's story being forwarded, notification on registration of an object which was previously owned by the user 114, notification on new stories posted for the object which was previously owned by the user 114, and notification on any important activities that may be occurring in relation to the object previously owned by the user 114. It should be noted that, every time a new story or write up is posted by a user, essentially the last known user in possession of the object, or a new registration related to the object happens by the user, all of the previous users who were in possession of the object at some point of time would be notified about said posts and registrations.

In context of the present invention, the non-registered user may be the user who may interact with the action tracking platform 108 as a guest. The non-registered user is provided with a user interface to accept the protocols of the action tracking platform 108 and register with the platform 108 by interacting with the authentication token provided in the card as shown in FIG. 4B (Eg. the user may scan the QR provided on the object to register with the action tracking platform). Alternatively, the user 114 may key in the authorization codes, such as PIN, object ID number to register with the action tracking platform 108. Alternatively according to some embodiment, the user 114 may be enabled to touch his smart phone against the NFC tag on the object for register with the action tracking platform 108.

Once the user 114 is able to register with the action tracking platform 108 either using the object 112 with associated credentials or directly by using some social site related login credentials (Eg. Facebook® or Google® login details). The user 114 is enabled to create or edit his/her profile and enter second set of data related to his/her profile. The user 114 is also enabled to enter the first set of data if it is not already done. The second set of data may preferably include a profile picture, name, address details, an email address, a phone number, a username, a brief on the education and hobbies. It should be understood that the object 112 related credentials i.e. the first set of data and the second set of data related to the user's profile would securely be stored by the action tracking platform 108 in one or more databases using a storage module 204 as shown in FIG. 3.

In accordance with another embodiment of the present invention, the platform 108 may allow the users 104, 114 not in possession of the object to register and login to access their account directly without requiring the first set of data associated with the object 102, 112. The created profile by the users 104, 114 may be similar to the profile of registered users, however with a limited access to all the features of the action tracking platform 108. The users 104, 114 may later provide first set of data associated with the object 102, 112 when they are in possession of the object 102,112. Alternatively, the action tracking platform 108 may notify the users 104,114 to key in or provide the first set of data provided on the object 102,112.

In the context of present invention, the action tracking platform 108 may be an application residing on the communication device 106, 116 held by the users 104,114. In another embodiment, the action tracking platform 108 may be a web based platform. In yet another embodiment, the action tracking platform 108 may be an add-on to a browser installed on the communication device 106. The action tracking platform 108 may include various functional modules, namely a data acquisition module 202, the storage module 204, an analytics module 206, and one or more processing modules 208. The functionalities of each of modules will now be described in detail in relation to FIG. 1-FIG. 2.

The data acquisition module 202 is configured to acquire the first set of data associated with the object 102 from the user 104 in possession of the object 102, and the second set of data provided by and related to the user 104. The user 104 may be a registered or an unregistered user. As discussed above, the object 102 may include but not limited to a card, a coin, a badge, a user wearable device, or a keychain. The first set of data associated with the object 102 may include an authorization code, and one or more recommended user actions for the user 104. The authorization code may be at least one of a Personal Identification Number (PIN), a QR code, an NFC code, and a Barcode and the recommended user actions may include a social service action as described above. Further, the second set of data that the data acquisition module 202 receive may include one or more profile related information of the users, such as but not limited to a username, a name, an address, and an email ID.

Further, once the data acquisition module 202 acquires the first set of data from the user 104 either through the authorization code provided on the object 102 for registering the user 104 or directly entered by the user 104 when the user login and key in his object Identification number and PIN, the data acquisition module 202 then transmit acquired first set of data associated with the object 102 to the analytics module 206.

The analytics module 206 upon receiving the first set of data associated with the object 102 from the data acquisition module 202 associates or correlates the first set of data associated with the object 102 to the second set of data related to the user 102 entered by the user 104.

Upon associating the first set of data to the second set of data, the analytics module 206 determines a third set of data associated with the first set of data. The third set of data may preferably be a profile related information of a previous user of the object 102 (as shown in Multi-user configuration of FIG. 2), one or more stories or write ups of user actions or missions shared by previous users who were associated with the same object 102, and location information of the user 104 and the previous user. The analytics module 206 extracts location of the user 104 and the previous user (who had passed on the object 102 to the user 104) and provide the location indication on a graphical map based on the extracted location.

The one or more processing module 208 is configured to process the data acquired and analyzed by the data acquisition module 202, and the analytics module 206 respectively. The one or more processing module 208 processes the first set of data associated with the object 102, the second set of data associated with the user 104, and the third set of data determined by the analytics module 206. The processing results in tracking of one or more locations of the object 102, and the user actions associated with the object 102. The location information associated with the object 102 is preferably as journey 414 of object 102. The journey 414 of object 102 may be presentable over the graphical map 412 for ease of users to locate the object journey route 414 as shown in FIG. 5E. According to the embodiment, the object journey route 414 presented on the geographical map 412 gives clear indication of location of the object 102 to the user 104 and the subsequent user 114, as shown in FIG. 5E.

Besides tracking the journey of the object 102, the processing module 208 also enables the user 104 or the subsequent user 114 to access and view one or more stories or write ups linked to the object 102 that may motivate the user 104 towards performing acts of kindness or good deeds.

It should be understood by those that the one or more processing module 208 is associated with a memory module. The memory module accessible by the one or more processing module 208 receives and stores data. The memory module may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc. The one or more processing module 208 may access the memory module to retrieve data. Examples of one or more processing module includes, but are not limited to a central processing unit (CPU), a front-end processor, a microprocessor, a graphics processing unit, a physics processing unit (PPU), a digital signal processor, and a network processor.

In an embodiment, the one or more processing module 208 is operationally coupled with a sub module, namely a notification module as shown in FIG. 5F. The module sends notifications 416 preferably including but not limited to likes that the user 104 might have received on the story posted by him in relation to previous object held by him, intimation on the time left for the user 104 to complete the mission or action he is involved in, notification on user's story being forwarded, any important activities that may be occurring in relation to an object that may be marked as favorite by the user 104. In an embodiment, the user 104 who was associated with the object gets notification via email, SMS, USSD, any type of message and mobile application every time when the a new user registered the object with the action tracking platform 108 or when the new user posts a story or write-up for the action performed on the action tracking platform 108.

The action tracking platform 108 further comprises the storage module 204 configured to store the first set of data associated with the object 102, the second set of data associated with the user 104, all the previous users of the same object 102, and all the subsequent users related information who may be in possession of the object 102. According to an embodiment, the storage module 204 may be a multi-tier storage system. In another embodiment, the storage module 204 may store the information in an encrypted format. In yet another embodiment, the storage module 204 may store the information in an indexed format. As The storage module 204 facilitates storage, retrieval, modification, and deletion of data in conjunction with various data-processing operations by the processing module 208, the analytics modules 206 and the data acquisition module 202. As known, the information in the storage module 204 may be retrieved through queries using keywords and sorting commands, in order to rapidly search, rearrange, group, and select the fields.

Although, not described in detail, and it should be understood by those skilled in the art, the storage module 204 may be a secure web servers and Hypertext Transport Protocol Secure (HTTPS) capable of supporting Transport Layer Security (TLS). Communications to and from the secure web servers may be secured using Secure Sockets Layer (SSL). An SSL session may be started by sending a request to the Web server with an HTTPS prefix in the URL. Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol) etc.

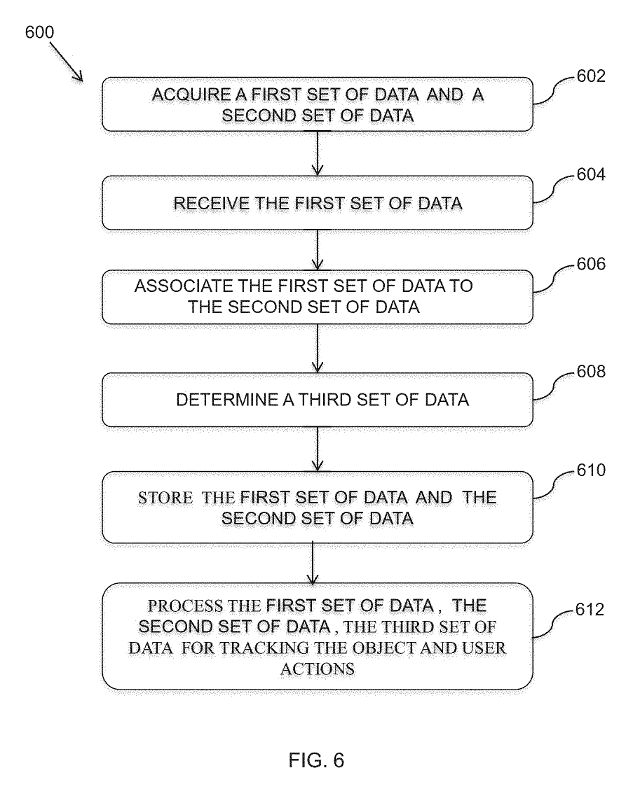

Referring to FIG. 6 illustrates a method flow for tracking an object and user actions associated with the object, in accordance with an embodiment of the present invention.

The method starts at block 602 that describes a step of acquiring or receiving, a first set of data associated with the object 102 from the first user 104 in possession of the object 102, and a second set of data provided by and related to the first user 104 by the data acquisition module 202. According to the embodiment, the object 102 preferably includes a card, a coin, a badge, a user wearable device, or a keychain.

According to the same embodiment, the first set of data associated with the object 102 preferably includes an authorization code, and one or more recommended user actions. The authorization code preferably includes but not limited to an object Identification code, a Personal Identification Number (PIN), a QR code, and a Barcode, The recommended user actions is preferably a social service action or an act of kindness to be performed by the user 104. According to the embodiment, the user 104 may be a registered or an unregistered user. According to the same embodiment of the present invention, the second set of data associated with the first user 104 includes one or more profile related information, such as but not limited to name, an address, an email, a phone number.

Flow then proceeds to step 604 that describes a step of receiving, the first set of data associated with the object 102 by the analytics module 206 from the data acquisition module 202.

Flow then proceeds to step 606 that describes a step of associating or linking the first set of data associated with the object 102 to the second set of data related to the first user 104 by the analytics module 206.

Flow then proceeds to step 608 that describes a step of determining, a third set of data associated with the first set of data by the analytics module 206. According to the embodiment, the third set of data may preferably be a profile related information of a previous user (not shown) of the object 102, one or more stories of user actions or missions shared by previous users who were associated with the same object 102, and location information of the user 104 and the previous user.

Flow then proceeds to step 610 that describes a step of storing, the first set of data associated with the object, the second set of data associated with the user by a storage module 204.

Flow then proceeds to step 612 that describes a step of storing processing, the first set of data associated with the object 102, the second set of data associated with the user 104, and the third set of data by the one or more processing module 208. The processing of the first set of data, the second set of data, and the third set of data by the one or more processing module 208 results in tracking of one or more locations of the object, and the user actions associated with the object 102.

Unlike the conventional systems and methods, the proposed system and method provides inspirations to other users to perform acts of kindness or social actions. The method attempts to create an unbreakable chain between the users passing on the object to one another and performing respective social actions. Unlike, the conventional systems and methods, the proposed system and method also brings in the excitement among the users enabling them to track journey of the object on the graphical map as the object moves from one user to the other user and navigate through chain of actions or reactions presented in the form of stories or write ups related the object either by logging into their account or by consistent notifications they receive from the platform.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Accordingly, the specification and drawings are to be regarded in an illustrative rather than a restrictive sense.

What is claimed is:

1. A system for tracking an object, and one or more user actions associated with the object using an action tracking platform communicatively coupled with one or more communication devices, the system comprising:
a data acquisition module, configured to acquire
a first set of data associated with the object from a first user in possession of the object, and
a second set of data provided by and related to the first user;
an analytics module, configured to
receive, the first set of data associated with the object acquired by the data acquisition module,
associate, the first set of data associated with the object to the second set of data related to the first user, and
determine, a third set of data associated with the first set of data;
a storage module, configured to store the first set of data associated with the object, the second set of data associated with the user; and
one or more processing module, configured to process the first set of data associated with the object, the second set of data associated with the user, and the third set of data determined by the analytics module, wherein the processing of the first set of data, the second set of data, and the third set of data by the one or more processing module resulting in tracking of one or more locations of the object, and the user actions associated with the object.

2. The system of claim 1, wherein the object comprising at least one of: a card, a coin, a badge, a user wearable device, or a keychain.

3. The system of claim 1, wherein the first set of data associated with the object comprising of at least one an authorization code, a brief guide and one or more recommended user actions.

4. The system of claim 3, wherein the authorization code comprising of at least one a Personal Identification Number (PIN), an object identification code, a QR code, an NFC code, and a Barcode,

5. The system of claim 3, wherein the recommended user actions comprises of a social service action, an act of kindness, or good deeds.

6. The system of claim 1, wherein the first user being at least one of: a registered, or an unregistered user.

7. The system of claim 1, wherein the second set of data associated with the first user comprising of one or more profile related information.

8. The system of claim 7, wherein the one or more profile related information comprises of a name, an address, a username, and an email.

9. The system of claim 1, wherein the third set of data associated with the first set of data comprising of at least one
a profile related information of a second user and previous users of the object,
one or more stories or write ups on user actions shared by the second user, or the previous users, and
location information of the first user and the second user or the previous users associated with the object at any point of time.

10. The system of claim 9, wherein the location information of the first user and the second user or the previous users associated with the object is presentable over a graphical map to track journey of the object.

11. A method for tracking an object, and one or more user actions associated with the object, the method being performed by an action tracking platform communicatively coupled with one or more communication devices, the method comprising:
acquiring, by a data acquisition module, a first set of data associated with the object from a first user in possession of the object; and a second set of data provided by and related to the first user;
receiving, by an analytics module, the first set of data associated with the object acquired by the data acquisition module;
associating, by the analytics module, the first set of data associated with the object to the second set of data related to the first user;
determining, by the analytics module, a third set of data associated with the first set of data;
storing, by a storage module, the first set of data associated with the object, the second set of data associated with the user; and
processing, by one or more processing module, the first set of data associated with the object, the second set of data associated with the user, and the third set of data determined by the analytics module, wherein the processing of the first set of data, the second set of data, and the third set of data by the one or more processing module resulting in tracking of one or more locations of the object, and the user actions associated with the object.

12. The method of claim 11, wherein the object comprising at least one of: a card, a coin, a badge, a user wearable device, or a keychain.

13. The method of claim 11, wherein the first set of data associated with the object comprising of at least one an authorization code, a brief guide and one or more recommended user actions.

14. The method of claim 13, wherein the authorization code comprising of at least one a Personal Identification Number (PIN), an object identification code, a QR code, an NFC code, and a Barcode.

15. The method of claim 13, wherein the recommended user actions comprise of a social service action, an act of kindness, or good deeds.

16. The method of claim 11, wherein the first user is at least one of: a registered user; or an unregistered user.

17. The method of claim 11, wherein the second set of data associated with the first user comprising of one or more profile related information.

18. The method of claim 17, wherein the one or more profile related information comprises of a name, an address, a username, and an email.

19. The method of claim 11, wherein the third set of data associated with the first set of data comprising of at least one
a profile related information of a second user and previous users of the object,
one or more stories or write ups on user actions shared by the second user, or the previous users, and
location information of the first user and the second user or the previous users associated with the object at any point of time.

20. The method of claim 19, wherein the location information of the first user and the second user or the previous users associated with the object is presentable over a graphical map to track journey of the object.
